(19) United States
(12) Patent Application Publication
(10) Pub. No.: US 2005/0039321 A1
(43) Pub. Date: Feb. 24, 2005

(54) Production system

(76) Inventors: Hinrich Stave, Mindelheim (DE); Heinrich Lutz, Dirlewang (DE)

Correspondence Address: JACOBSON PRICE, HOLMAN & STERN;PROFESSIONAL LIMITED LIABILITY COMPANY, 400 Seventh Street, N.W., Washington, DC, 20004, US

(21) Appl. No.: 10/804,076

(22) Filed: Mar. 19, 2004

(30) Foreign Application Priority Data
Mar. 21, 2003 (DE) 203 04 653.6
Apr. 28, 2003 (DE) 103 19 122.4
Oct. 10, 2003 (DE) 103 47 913.9

(51) Int. Cl. B23P 23/00

(52) U.S. Cl. 29/563; 29/33 P; 29/DIG. 50; 29/DIG. 94

(57) ABSTRACT

The invention refers to a production system, in particular machining line, which is formed, on the one hand, by one or more process modules which machine on work pieces and, on the other hand, is at least formed by one logistics module, and the logistics module provides a conveying of the work pieces, wherein the logistics module as a pre-assembled system module provides with and disposes of work pieces to a number of process modules, and the process module as system module can be connected to the logistics module.

### BACKGROUND OF THE INVENTION

Production systems, in particular machining lines, respectively machining centers, are known. Production systems of this type are constructed in such a way that the work pieces which have to be machined on, respectively the components, are conveyed on a conveyor line to the single machine tools, respectively centers, and usually they are then conveyed through these. It is also known to combine continuous conveyor lines with machine tools in such a way that a transmitter, respectively a translator, is provided on the machine tool which conveys then the work pieces or components into the machine tool. For that purpose in the known solutions the conveyor line is interrupted. The machining center itself needs for that purpose suitable translators, respectively transmitters, means, which have to be integrated in the conveyor line.

It is, for example, also known to equip single machining centers with a common translator. Parallel to a row of machining centers there is a loading belt and an unloading belt. For example, the translator can move parallel to that and picks up a work piece from the loading belt, puts it into the machining center and, after that, removes the finished work piece and translates it again to an unloading belt. The design of production systems of this type is extremely complicated because of the combination of conveyor belt, translator, respectively loader and unloader, and needs, as a rule, a considerable technical construction and assembling effort in order to combine these components of a production system with each other.

Basing on the state of the art described above it as an object of the invention to provide a production system which can be constructed as simply as possible.

### BRIEF SUMMARY OF THE INVENTION

The invention comes from the state of the art described above and proposes in order to solve the problem in question a production system, in particular a machining line, which is formed modular, on the one hand, by one or more process modules which machine on work pieces and, on the other hand, is formed by at least one logistics module, and this logistics module provides the conveying of the work pieces, the logistics module as pre-assembled system module supplying and disposing of a number of work pieces for the process modules, and the process module being designed to be connected as a system module to the logistics module.

The object according to the invention is also solved by a production system, in particular a machining line for the production and/or machining of work pieces, components or the like, consisting of different module types designed as system module for machining and conveying which can be connected, respectively combined, with each other in any number.

Because of the design of the production system with a module-like construction of the single system components, respectively system modules, it is now possible to conceive suitable modules for very different tasks for the production system and to combine them with each other, respectively among each other, in any sequence and in any number. Therefore it is, for example, possible to construct a conveying line module-like which then, depending on the requirement of each plan, respectively customer wish, can be arranged in suitable length with the branching units necessary for it along a machining line with machine tools, respectively stations. The individual modules here are designed in such a way that they can be even transported easily. The module-like construction in particular is the reason why the modules do not have to be dismantled, respectively have to be dismantled only slightly, for transport. This reduces the effort for such works considerably as these are, in particular, essentially also operations which have to be carried out mechanically with a comparatively high manual effort. If the conception of the production system with a module-like construction is carried out consequently, besides the modular construction of the conveying lines, even such a construction is possible for the individual machining stations, which are then, for example, designed as process module also in the manner described above, in order to combine a combination with the conveying lines, respectively modules, and other system modules, like, for example, very different machining stations.

Therefore a development of the production system according to the invention is characterised by the fact that the process module and the logistics module are system modules separated from each other.

According to an advantageous development of the production system according to the invention it is provided that the process module has a supplying, respectively disposal, unit for work pieces which takes the work piece(s) from the logistics module guided along the process module into the process module and, after that, conveys it again to the logistics module.

For that purpose it is an advantage if the process module is arranged either directly at the logistics module or is supplied with and disposed of work pieces via a supplying, respectively disposal, unit for work pieces and only the logistics module provides a conveying of the work pieces to the process modules. This has the consequence that the logistics module can be carried out, of course, as uniform, closed conveying line with the module-like construction already mentioned and therefore a rationalisation of the production for logistics modules of this type is consequently possible. Thus it is, for example, now possible by means of this module-like construction that the logistics module can be subdivided into further components which are also designed module-like. However it is also possible to provide then certain machine units within such a module.

A development of the production system according to the invention is therefore characterised by the fact that the logistics module has a conveying unit for the conveying of the work pieces within the system.

According to the invention it has also bee found to be an advantage if the logistics module has for the transport of energy and media necessary for the process a conduit unit for the supply of the process modules as well as for their disposal.

A special embodiment of the production system according to the invention is characterised by the fact that the logistics module is indicated by a stand which, arranged tier-like, has at least two conveying modules, wherein a disposal module, respectively a part of it, for example a draining channel for draining cool or lubrication agents, chips or the like is arranged below the conveying modules, and in another level indicated by the stand the supplying module, respectively a part of it, for example pipe lines for cooling water, process gases, cable or the like is arranged.

In summary, the following objects and advantages are given for the logistics module according to one or more of the embodiments described above:
uniform conveying of the work pieces within the complete system,
supply of the process modules with energy and media through a central unit,
supply of the process modules through the logistics module, concerns for example:
   electric energy, for example current conducted in current rails, hydraulic oil, compressed air, process gases, cooling liquid for drives, tempered water for thermal stabilisation of the process modules and/or the work pieces, cooling lubricants for cutting machining processes, if necessary in different pressure levels and filter quality levels,
removal of residue and auxiliary materials out of the process modules, for example chips, process wastes, cooling lubricants, steams, fog, smoke
providing of the lines for data exchange within the system and to the outside,
protection of persons against possibly hazardous movements or noise sources within the logistics module, realised by means of integration of necessary protection devices or panelling in the module,
providing of standardised interfaces for connecting other system modules.

Therefore the module is designed as pre-assembled stand which contains one or more conveying lines for work pieces. These lines may be, for example, arranged one beside or one above the other. For example the lines may also be designed as running belts, roller belts or friction roller belts. The work pieces are conveyed on these belts, however preferably not necessarily on pallets, with standardised interfaces. The work pieces may even be conveyed directly, without pallet. Furthermore cables, tubes and pipes are arranged in the stand for supplying and disposal of the system modules as well as for data exchange, if necessary rail distributors for electric energy and/or distributors for pneumatic energy, conveyors, conveyor belts and/or conveyor channels for the removal of process waste, for example cooling lubricants and chips during the cutting machining. These conveyors or channels are arranged here preferably in the bottom region of the stand. It is provided here to arrange protection panelling, sound-absorbing panelling, as far as necessary, on the logistics module. Interfaces are provided furthermore for the addition of other system modules. It is also provided to conceive the logistics module as completely pre-assembled unit which can be tested. By means of that it can be realised in different, if necessary standardised, lengths in order to design any production system with it. In connection with preferably provided branching modules any system arrangement can be realised. These may be one or more lanes with any cross connection and closed circuits.

Therefore a development of the production system according to the invention provides conveniently a branching module as system module which serves for connecting several logistics modules to each other angular at one level and/or at different levels.

It is an advantage here if these branching modules are arranged on the conveying modules corresponding for a transferring, respectively taking over, to the process modules.

An advantageous development of the invention also provides that the branching module comprises loading and unloading modules and/or packing, respectively unpacking modules, respectively stations.

Another aspect of the production system according to the invention is the fact that the branching module is indicated by at least one switch point, rotation station, lifting station for distributing the work pieces, respectively the pallets, in different conveying levels and transmitters, respectively translators or the like.

According to an advantageous development of the production system it is provided, as described before, that the production system has a supplying module as system module which guarantees the supply of the process modules with energy and media.

A development of the production system according to the invention is characterised by the fact that a disposal module is provided as system module in order to collect and, if necessary recycle, process wastes and used materials. It has proved to be an advantage here if an operating module is provided consisting of a supplying module and a disposal module which takes over supply as well as disposal tasks of the production system as combining system module.

Another aspect of the production system according to the invention is given by the fact that the system modules are designed pre-assembled and, as a unit, transportable without any or with minimum dismantling effort. As already described the consequent construction in a module-like way makes it possible that assembling and dismantling efforts can be saved before the actual assembling of the machining line, respectively the production system altogether. Also a moving to other production sites later on is made considerably easier.

A special embodiment of the production system according to the invention is characterised by a logistics module, preferably with its own modular construction which is designed for
the conveying of the work pieces within the system,
the supply of the process modules with energy and media,
the removal of process residues and auxiliary materials out of the process modules,
the providing of data exchange media for the exchange of information and data within the system,
the protection of persons against risks like hazardous movements, noise, burns, respectively scalds, or the like.

By means of that very different logistic problems, respectively auxiliary processes within the production system have already been solved by a logistics module as described before. Of course, a modular construction of the single installation parts is really useful here as well. However, it is, according to the invention, also provided that installations, respectively installation parts can be integrated in a logistics module which has no modular construction of their own.

According to the invention it is an advantage if, according to an advantageous development of the invention, a logistics module is provided which has interfaces for connecting, respectively joining, at least one process module and/or at least one other logistics or conveying module or supplying modules, branching modules, installations or parts of installations.

Furthermore it is an advantage if the process module is designed by machines for machining work pieces, for example for cutting, transforming, for assembling, respectively separating through testing stations, assembly stations, adjustment stations, surface treatment stations, packing or unpacking stations, marking stations for marking work pieces, pallet loading or unloading stations and cleaning stations. Of course, it is an advantage here if the installation parts mentioned before are also characterised by a module-like construction.

A development of the production system according to the invention provides that the supplying module is designed in such a way that electricity, liquids, process gases, gases and/or gases under pressure, respectively other media needed in the modules are recycled and/or provided.

It is particularly convenient here if the supplying module takes over centrally the supply of the media needed in the process modules at least for a part of the process modules, preferably for all process modules in the production system simultaneously. This makes it possible to combine in another rational way supplying systems provided before locally at the single installation parts, machine tools and the like. Thus it was usual, according to the state of the art, to provide each process module as machining station, respectively machine tool, with its own supply devices, like pumps, filters, suction devices and the like. This required a number of individual installation parts, respectively aggregates, which now can be combined centrally in a supplying module. This makes, on the one hand, the construction of the process modules themselves simpler and, on the other hand, of course also the construction of the complete production system.

A development of the production system according to the invention provides that in the same way as described before for the supplying module, a central disposal module is provided which serves centrally for the disposal for the production system altogether, but at least for a part of the process modules. Preferably it is provided here, as already described above, that the disposal module realises for all process modules the disposal of wastes, used materials by means of a central collection and recycling of these materials. Here also a number of necessary completion parts, individual installations, respectively aggregates on the process modules can be saved as now a central collection of these media is carried out. By means of that pumps, suction devices, filter installations and the like can be saved in the same way as it has been described before. The collection of the disposal installation parts, so far arranged in the single process modules in the disposal module has the advantage to arrange these, if necessary, with a slightly higher capacity in the disposal module and to save them instead in the process modules. If the solution described before for the supplying module and for the disposal module cumulates in a production system with, for example, fifteen different process modules a considerable number of installation parts results which can be saved by means of this efficiency measurement.

It is a special advantage here if the disposal module collects, recycles and guides again to the production circuit of the production system at least a part of the used auxiliary material, cooling agents, process gases and the like. By means of that further efficiency results occur which appear in the combination of the tasks which have to be realised in a uniform disposal module.

A development of the production system according to the invention provides therefore a disposal module which carries out centrally the suction of steam, fog, smoke or the like via a common central suction system for several, preferably all process modules.

Another aspect of the invention is given by the fact that the conveying module is indicated by conveyor lines, running belts, conveyor belts, slide guides or the like. This guarantees that within the logistics module the conveying module is subordinated altogether to the module-like construction of the complete production system. However, it is, of course, also possible to use within a conveying module the installation parts known so far like conveyor lines, friction roller lines and the like. They only have to be adapted to the module-like construction of the complete system.

According to a convenient development of the solutions described above it is provided that the conveying module is indicated by at least two or more conveyor lines arranged one above the other tier-like.

It is, of course, also possible that the conveying module is characterised by the fact that at least two or more conveyor lines are provided arranged one besides the other.

It is particularly convenient if the supplying module, the disposal module or the operating module have a sound-absorbing housing which holds the noise-generating aggregates like compressors, pumps, condensers, vacuum pumps and the like.

Furthermore it has turned out to be an advantage if the housing of the supplying module, respectively the disposal module, or the operating module comprising both modules has an air-conditioning, respectively a cooling, through which the heat generated by the aggregates is dissipated.

It has turned out to be another advantage that the supplying module contains components for a common supply of several, preferably all, process modules, like, for example, hydraulic aggregate, cooling lubrication aggregate, compressed air aggregate, aggregate for thermal stabilisation of the process modules, for example by providing tempered water, gas supply aggregate, energy supply and switching stations, respectively aggregates.

It is also an advantage in the production system according to the invention if it is characterised by the central energy supply, for example contact-less guided conductor rails with separating switches and tapped contact-less or guided by cables, the central energy supply being preferably integrated in the supplying module(s).

The central energy supply has the job to recycle and provide power, liquids and gases in the form required by the concerned system modules. This can be carried out, for example, by a central feeding point for electric energy for the complete system. Simultaneously main switch, fuse, transformers for adjusting to very different current and network structures may be provided. Furthermore it is an advantage if frequency converters are provided for adjustment to different supply frequencies, if necessary even an emergency power generation, batteries, accumulators or generators. The supply of compressed air, its filtration, its pressure adjustment, the drying of the air but also the oiling of the compressed air, if necessary, can be realised centrally by means of a supplying module. Furthermore the supplying module serves for the supply of all installation parts of the production system with cooling liquid. For that purpose the supplying module contains for example a cooling aggregate which supplies all modules with cooling agent. Ideally no further heat exchangers and temperature control devices are necessary on the process modules. The liquid may not only be used for cooling, but also for the selected heating within the process modules. If necessary, several circuits have to be provided for cooling, respectively heating. The supplying module may also provide a central supply of the production system with laser energy. Even process gases as well as the recycling of process gases for the process modules are provided centrally in the supplying module. The same goes for the lubrication system which is provided, for example, by a central lubrication aggregate for the complete system. The process liquids are also combined within the supplying module. This may, for example, be realised by providing tanks, pumps, pressure control devices and filters for the process liquids in the supplying module. Furthermore it is provided that high-pressure lubricants are supplied centrally for cutting machining processes for the complete production system by means of the supplying module. If necessary it is then only required to provide separate pressure control devices in the process modules.

The invention is characterised by a common fire protection module, respectively system. This fire protection module may be, for example, a sprinkler system which is also constructed module-like and is altogether integrated in the production system.

The production system according to the invention is further characterised by the fact that the different part systems, respectively module types, are designed, respectively formed, redundantly within the supplying module.

Furthermore the invention proposes that the process module has a logistics element, and the process module can be connected to the logistics element with the logistics module. It is really helpful and convenient if on the process module a small, if necessary short, logistics element is arranged which serves in particular for conveying the work pieces within the process module. By means of this also the interface for the connection with the logistics module is provided.

In the same way it is an advantage that the process module has a supplying element which can be connected to the supplying module. The process module, for example a cutting machine tool, is operated with rinsing, respectively cooling, liquid. After that these media have to be disposed of. As the media occur directly under the machine tool in the process module it is convenient to arrange the corresponding supplying element, that is for example a chip conveying channel or the like, as supplying element in the process module, which then is connected with the supplying module which is part of the logistics module.

According to the invention it is also an advantage that there is a central supplying module. This central supplying module serves for the supply of a number of process modules.

Conveniently it is provided that there is an integrated supplying and disposal module because in particular for example during the recycling of auxiliary materials which occur anyway as material to be disposed of, the auxiliary materials can be fed again into the supplying module immediately and be provided.

It is also an advantage that a common stand of the logistic module is provided for the conveying module and for the supplying, respectively disposal module. Such a variant is shown for example in FIGS. 2, 4 and 5. Such a variant is an advantage with regard to the availability of the complete production line as in every case the process modules remain available from one side. Alternatively to that it is possible that for the conveying module, on the one hand, and for the supplying, respectively disposal, module, on the other hand, an individual stand each is provided. Here the modules may be arranged on both sides with regard to the process module or each on one side, if necessary one besides or above the other.

In summary it is stated that the central energy and media recycling, for example in the supplying module, has, among others, the following advantages:
A number of small aggregates is avoided in, respectively on, the process modules. This results in a reducing of costs, simpler maintenance, for example by an oil change which is only required on a central unit, respectively a central aggregate, a higher availability by a smaller complexity of the complete system.
Pinnacles of use of single process modules are compensated at least partly resulting in a smaller installed performance altogether.
Better control, for example of cooling circuits, because load pinnacles can be egalized and, for example, a large, respectively larger, central tank may be provided.
Space saving is another effect with the process modules.
By means of centralising the noise sources like pumps and fans a simpler and improved noise protection results.
This goes in the same way also for the installation parts of the disposal modules.

### BRIEF DESCRIPTION OF THE DIFFERENT VIEWS OF THE DRAWINGS

The invention will be described in the following by means of embodiments and drawings in further detail.

In the figures:

FIG. 1 a block diagram of an embodiment of a production system according to the invention,

FIG. 2 an example of a logistics module according to the invention,

FIG. 3 a part section of a block diagram of another embodiment according to the invention,

FIG. 4 a top view of a further example of the production system according to the invention and

FIGS. 5, 6 each a view of details of the production system according to the invention, according to arrow V, VI in FIG. 4.

### DETAILED DESCRIPTION OF THE PREFERRED EMBODIMENT

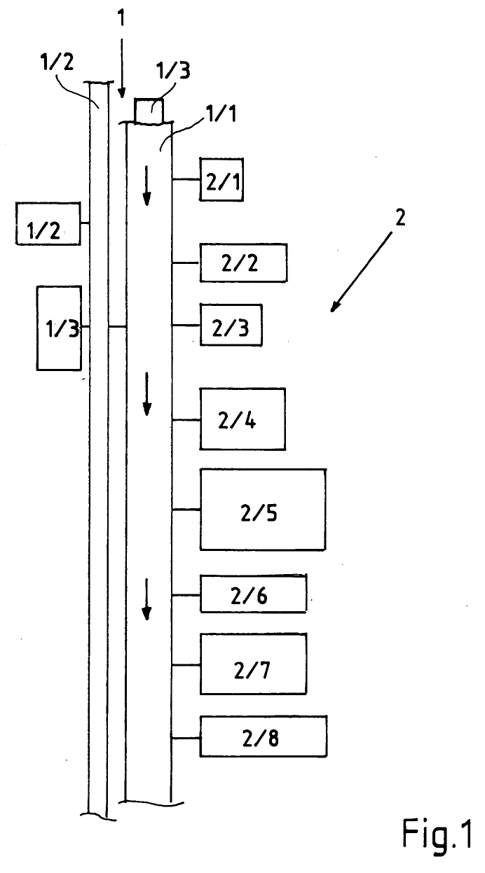

FIG. 1 shows a block diagram of an embodiment of the production system according to the invention. The arrow with the reference number 1 indicates the logistics module. The logistics module 1 consists of a conveying module 1/1, a supplying module 1/2, a disposal module 1/3 as well as a branching module 1/4 not shown in this drawing. The conveying module 1/1 may be here a roller conveyor, a slide guide, a friction roller conveyor or the like, which approaches, for example, work pieces 3 for machining to the process modules 2 and hands them over to them, if necessary, there via branching modules 1/4.

The supplying module 1/2 comprises in this embodiment two pieces. Thus, for example, it comprises a supplying line on which the individual conduits for the supply of the process modules 2 are arranged. The box with the reference number 1/2 indicates a supplying module which provides centrally, for example, the recycling of the process media like energy, gas, pressure and the like as described above. The disposal module 1/3 is also shown in two pieces, by providing for example a central disposal station where all occurring auxiliary materials which should be disposed of are collected and/or recycled. This is shown diagrammatic by the box with the reference number 1/3.

Below the conveying module 1/1 there is a central collecting trough where for example chips and draining cooling water is collected and transported in the disposal module 1/3 indicated by the box. There the media are separated, cleaned and, if necessary then again conveyed to the supplying module 1/2, or directly conveyed to the process modules 2. The single boxes of the process modules 2 indicate the cutting module 2/1, a test module 2/2, an assembly module 2/3, an adjustment module 2/4, a surface treatment module 2/5, a cleaning module 2/6, an indication module 2/7 and a packing module 2/8. The arrangement is chosen for showing how, by means of the single modules, a production system can be designed in very different ways by means of the module-like construction. This is now possible according to the invention. The single module parts are here adjusted to each other concerning their size as well as their function and can be combined with each other in any way. The advantage of such a module-like construction becomes evident because the single module types can be manufactured even independently from each other. It is simply necessary to provide all modules with suitable interfaces so that a joining, respectively combination, is possible without any problems.

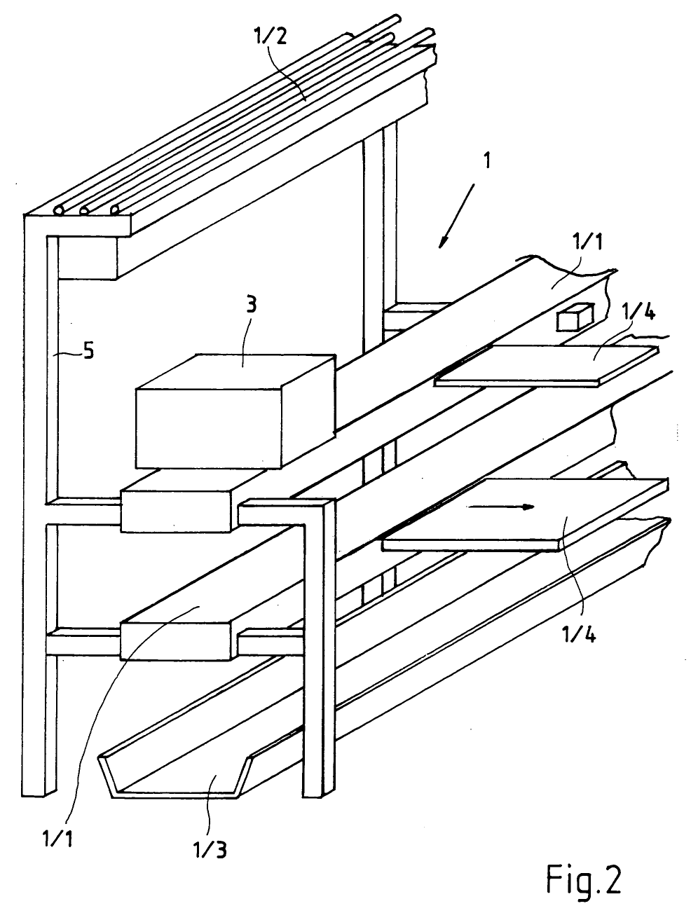

FIG. 2 shows an embodiment of a logistics module 1. The arrow with the reference number 1 indicates here the complete logistics module. Reference number 1/1 indicates here two conveying modules which are arranged one above the other tier-like. On the top conveying module 1/1 a work piece 3 is located which is conveyed on the conveying module 1/1 to a process module 2. Reference number 1/4 indicates branching modules on the respective conveying modules 1/1. This is also only indicated schematically and has by no means to be understood as technical drawing. By means of the branching modules 1/4 the work pieces 3 can be conveyed to the single process modules 2.

However, it is also possible to combine different logistics modules with each other, respectively to branch them, so that very different process lanes can be realised. The branching modules 1/4 then serve for distributing into the different lanes and levels. Of course also a tier-like exchange of the work pieces 3 to the respective conveying modules 1/1 is provided. Reference number 5 indicates the stand for the complete logistics module. The stand 5 here carries the conveying modules 1/1 as well as the supplying module 1/2 and the disposal module 1/3. The supplying module 1/2 is arranged here on the left hand side on the stand 5 in another plane above the conveying modules 1/1. Here conduits, respectively cables, are indicated only schematically as parts of the supplying module 1/2. The disposal module 1/3, respectively a part of it, is designed as a trough and serves for collecting the wastes, respectively the draining cooling, respectively lubrication, agents. This trough itself may have suitable conveying means which lead for example the chips to a central chip collecting device. For that purpose even a central unit may serve as it is for example indicated in FIG. 1 with the reference number 1/3 as box. Of course, it is, according to the invention, also provided that the logistics module is constructed in such a way that two conveying modules 1/1 are arranged one besides the other. However, the invention is not restricted to the number of two conveying modules 1/1. If it is necessary it is, of course, even possible to provide a multitude of conveying modules simultaneously one besides the other, respectively above the other.

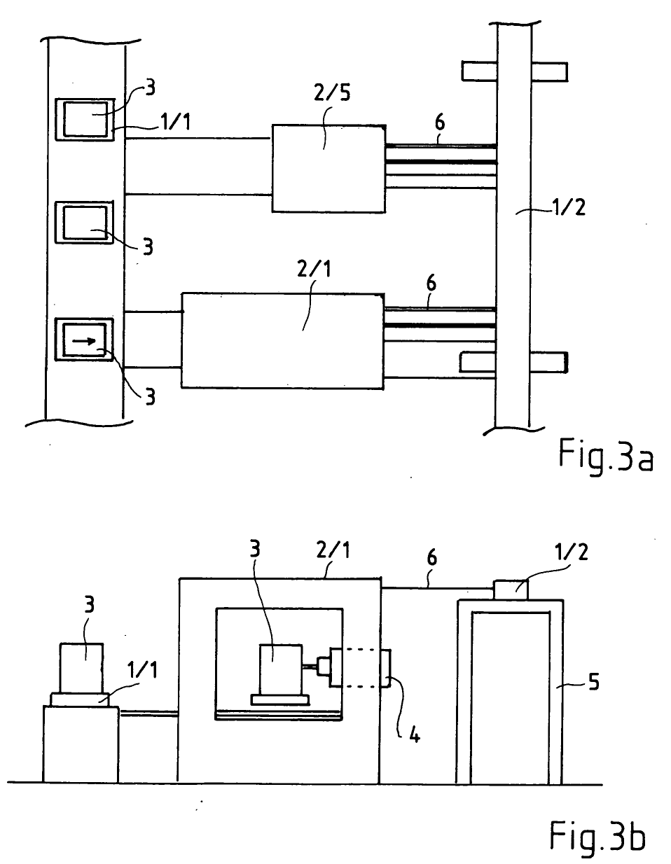

FIGS. 3a and 3b show a part section of another embodiment of the invention. FIG. 3a is here a top view of a part of a production system according to the invention. Again a conveying module, for example a conveyor belt, is designated with the reference number 1/1 on which the work pieces 3 are located. The box 2/1 indicates, for example, a cutting module into which a work piece 3 is conveyed. Another box 2/5 indicates a surface treatment module where, for example, the surfaces of work pieces 3 can be machined on in order to achieve smoother surfaces of the work piece. The advantage of the arrangement according to FIGS. 3a and b is the fact that a supplying module 1/2 is arranged on the right hand side of the process modules 2. Here a stand 5, as it can be seen in FIG. 3b, is arranged in such a way that for example persons below the stand can move and are not impeded by the parts of the supplying module 1/2 which is arranged on the stand 5. Reference number 6 indicates conduits or cables or the like, which supply the process modules 2 with the suitable media or energy. FIG. 3b shows a section view through the embodiment of FIG. 3a. Here also, indicated only schematically, the cutting module 2/1 can be seen in the center of the drawing where, for example, a work piece 3 is being positioned for machining. Reference number 4 marks a tool spindle for cutting machining of the work piece 3. Reference number 6 indicates the conduits through which the energy and media supply is carried out into the cutting module 2/1. As already mentioned the stand 5 is designed in such a way that persons can stand and move below it without any problems. This limits the risk of accidents considerably. On the left hand side of the drawing in FIG. 3b a conveying module 1/1 is shown on which also a work piece 3 is positioned.

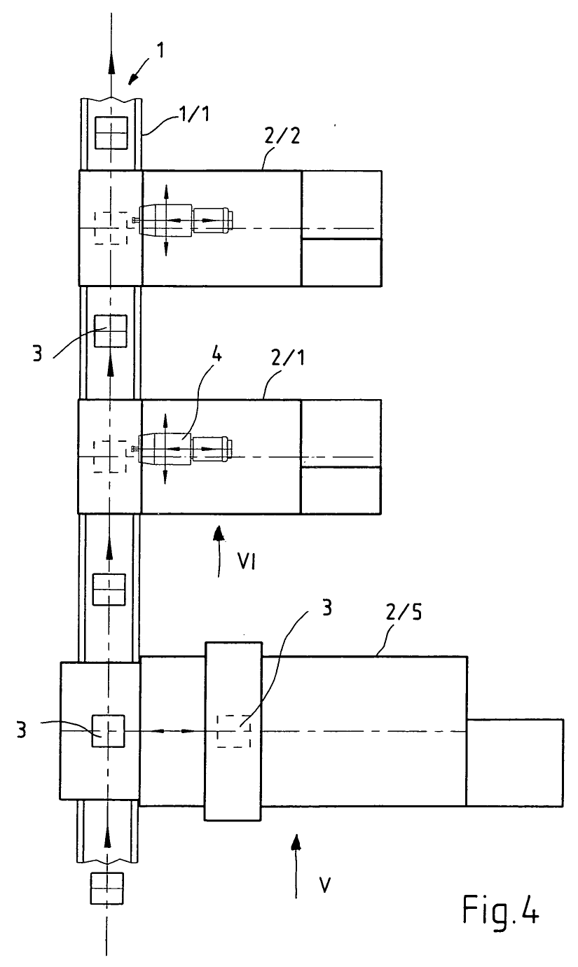

In FIG. 4, similar to FIGS. 3a, 3b, another variant of the embodiment of the production system according to the invention is shown. Here a number of process modules 2/5, 2/1, 2/2 are arranged along the conveying unit 1/1.

For example the process module 2/5 is a machining center with the option for more complex machinings, on the other hand, process modules 2/1, 2/2 carry out only a few machining steps. The logistics module 1 is arranged in this example on one side left with regard to the process modules 2.

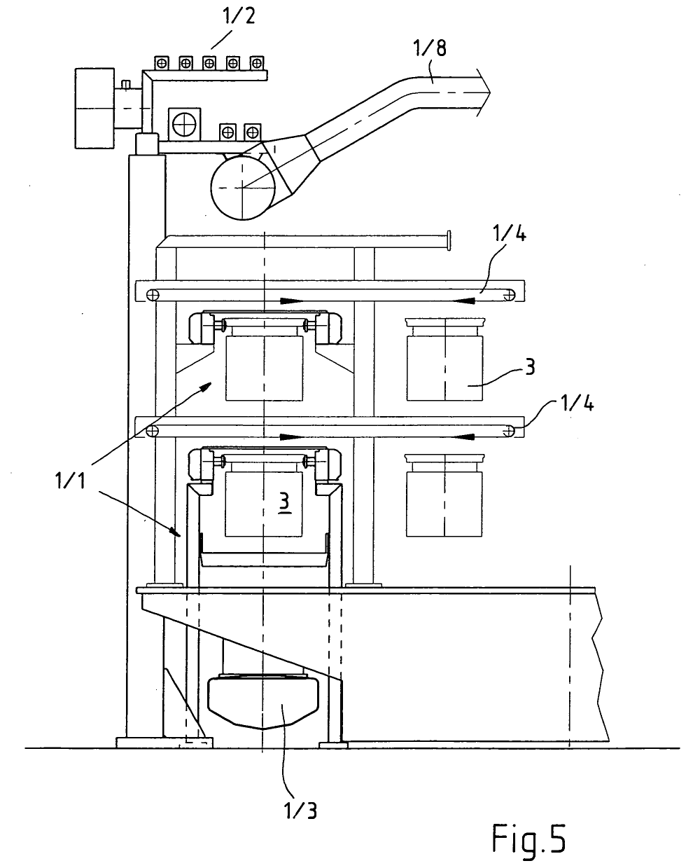

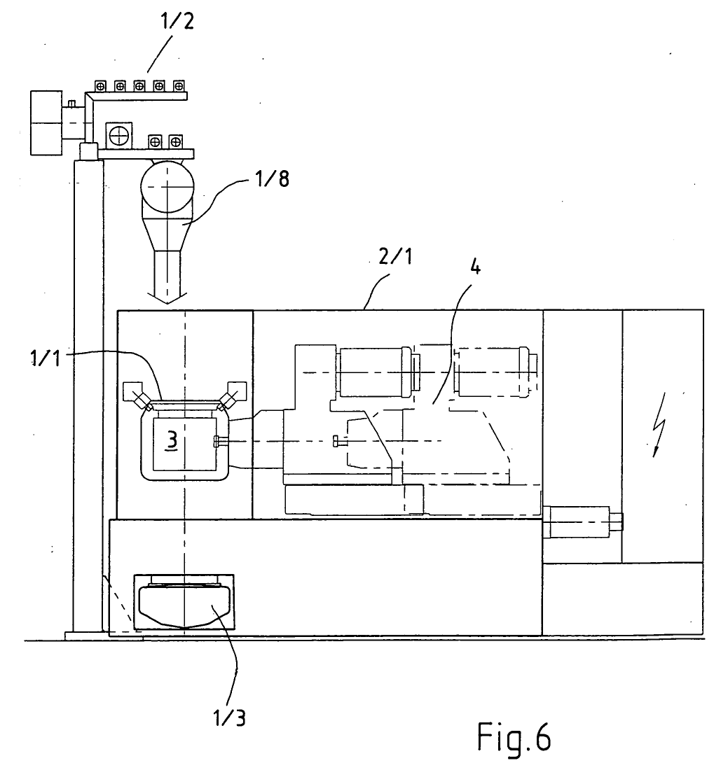

FIGS. 5, 6 show views in the direction of conveying within the production system according to the invention. The views correspond with the arrows V, VI in FIG. 4. It is evident here that, after the first more complex working machining center 2/5 as process module, to which the work pieces which have to machined are conveyed to or away in two tiers one above the other (FIG. 5), in FIG. 6 a serial machining is provided as here the conveying unit 1/1 passes through the working room of the process module. For that purpose in FIG. 4 in the process module 2/5 a work piece 3 is indicated in a dashed line which is removed from the conveying unit on the right hand side. The arrangement is chosen here (FIG. 5) in such a way that in the top conveying unit 1/1 the raw parts not yet machined on are approached, which are then machined on in the machining unit 2/5 and then are handed over there to the bottom removal conveyor belt 1/1 for machined work pieces. Such an arrangement allows even basically a redundant arrangement of process modules or the parallel machining in order to achieve a suitable capacity, respectively productivity. As the machining steps are shorter in the process modules 2/1, 2/2 the hold time of the work pieces 3 in them is clearly shorter so that these machining steps may be carried out in a serial sequence. If necessary on the inlet or outlet side of the double-tier arrangement according to FIG. 5 lifts are provided in order to bring the work pieces in the correct position one above the other of the approaching or removal conveyor belts.

In the example shown in FIG. 3b process modules 2 are found between the supplying and disposal unit 2/2 and the conveying unit 1/1. In the embodiments shown in FIGS. 5, 6 these are positioned one above the other, additionally in the region of the disposal also an evacuation channel 1/8 being provided.

The claims submitted with the application now and to be submitted later on constitute attempts at wording without prejudice to the obtaining of continuing protection.

If it turns out here during closer examination, in particular also of the relevant state of the art, that one of the features may be favourable for the object of the invention, however not decidedly important, of course, already now a formulation is endeavoured which does no more include such a feature, in particular not in the main claim.

The relationships cited in the dependent claims refer to the further development of the subject of the main claim provided for by the features of the respective sub-claim. However, these relationships must not be interpreted as waiving the requirement to obtain independent, subjective protection for the features of the related sub-claims.

Features which so far have only been disclosed in the description may be claimed in the course of the proceedings as being of significance to the invention, for example for delimitation from the prior art.

Features only disclosed in the description or single features from claims which comprise a number of features, may be used at any time for delimitation from the prior art in the first claim, and that is even if such features have been mentioned in connection with other features, respectively in connection with other features have lead to particular convenient results.

Although the invention has been described by exact examples which are illustrated in the most extensive detail, it is pointed out that this serves only for illustration and that the invention is not necessarily limited to it because alternative embodiments and methods become clear for experts in view of the disclosure. Accordingly changes can be considered which can be made without departing from the contents of the described invention.

1. Production system, in particular machining line for the production and/or machining of work pieces, components or the like, comprising different module types designed as system module for machining and conveying, which can be connected, respectively combined, with each other in any number, and a process module, respectively a logistics module, being provided as system modules.

2. Production system according to claim 1, characterised in that the production system is formed modularly, on the one hand, by means of one or more process modules which machine(s) on the work pieces and, on the other hand, is formed by at least one logistics module, and the logistics module provides the conveying of the work pieces, the logistics module as a pre-assembled system module supplying a number of process modules with work pieces and disposes of them, and the process module as system module can be connected with the logistics module.

3. Production system according to claim 1, characterised in that the process module has a unit for supplying with, respectively disposing of, work pieces which takes the work piece from the logistics module extending along the process module into the process module and, after that, conveys it again to the logistics module.

4. Production system according to claim 1, characterised in that the process module is either arranged directly at the logistics module or is supplied with work pieces, respectively the work pieces are disposed of, via a work piece supplying unit, respectively a work piece disposing unit, and only the logistics module provides a conveying of the work pieces to the process modules.

5. Production system according to claim 1, characterised in that the logistics module (1) has a conveying unit (1/1) for conveying the work pieces (3) within the system.

6. Production system according to claim 1, characterised in that the logistics module (1) has a conduit unit for the conveying of energy and for the media necessary for the process for the supplying of the process modules (2) as well as for their disposal.

7. Production system according to claim 1, characterised in that the logistics module (1) has at least one conveying module (1/1).

8. Production system according to claim 1, characterised in that the logistics module (1) is formed by a stand which has, arranged tier-like, at least two conveying modules (1/1), where, below the conveying modules (1/1) a disposal module (1/3), respectively a part of it, is arranged, for example a disposal channel for draining cooling liquid, respectively lubricating stuff, chips or the like, and, in another level, defined by the stand, the supplying module (1/2), respectively a part of it, for example pipes for cooling water, process gases, cables or the like is arranged.

9. Production system according to claim 1, characterised in that a branching module (1/4) is provided as system module which serves for connecting several logistic modules (1) angular with each other at the same level and/or at different levels.

10. Production system according to claim 1, characterised in that the logistics module (1) has at least one conveying module (1/1) and on the conveying module(s) (1/1) branching modules (1/4) are arranged corresponding for a transfer, respectively take over, to the process modules (2).

11. Production system according to claim 1, characterised in that a system module is provided as branching module (1/4) which serves for connecting several logistics modules (1) angular with each other at the same level and/or at different levels, and the branching module (1/4) comprises loading and unloading modules and/or packing or unpacking modules, respectively stations.

12. Production system according to claim 1, characterized in that a branching module (1/4) is provided as system module which serves for connecting several logistics modules (1) angular to each other at the same level and/or at different levels, and the branching module (1/4) is formed by at least one distributing point each, rotational station each, lifting stations for distributing the work pieces (3), respectively pallets, in different conveying levels and transmitters, respectively translators or the like.

13. Production system according to claim 1, characterized in that the production system (1) has a supplying module (1/2) as system module which guarantees the supply of the process modules (2) with energy and media.

14. Production system according to claim 1, characterized in that the production system has a disposal module (1/3) as system module for collecting and, if necessary, recycling, respectively removing, process wastes and used materials.

15. Production system according to claim 1, characterised in that the production system has an operating module formed by a supplying module (1/2) and a disposal module (1/3), which takes over supply as well as disposal tasks of the production system as a combining system module.

16. Production system according to claim 1, characterised in that the system modules are pre-assembled and designed in such a way that they can be transported as a unit without any or with minimum effort for dismantling.

17. Production system according to claim 1, characterised by a logistics module (1), preferably with individual modular construction which is designed for
the conveying of the work pieces within the system
the supply of the process modules with energy and media
the removal of process remains and materials out of the process modules
the providing of data transfer media for the exchange of information and data within the system and
the protection of persons against hazards like hazardous movements, noise, burns, respectively scalds, or the like.

18. Production system according to claim 1, characterised by a logistics module (1) provided with interfaces for connecting, respectively joining, of at least one process module (2) and/or connecting of at least one other logistics or conveying module (1/1), or of supplying modules (1/2), disposal modules (1/3) and branching modules (1/4).

19. Production system according to claim 1, characterised in that the process module (2) is designed by machines for machining work pieces, for example for cutting, transforming, for assembling, respectively separating, by testing stations, assembling stations, adjustment stations, surface treatment stations, packing or unpacking stations, identification stations for identifying work pieces, stations for loading and unloading pallets and cleaning stations, preferably with modular-like construction.

20. Production system according to claim 1, characterised in that the production system (1) has a supplying module (1/2) as system module which guarantees the supply of the process modules (2) with energy and media, and the supplying module (1/2) is designed in such a way that it recycles and/or provides current, liquids, process gases, gases and/or gases under pressure, respectively other media needed in the process modules (2).

21. Production system according to claim 1, characterised in that the production system (1) has a supplying module (1/2) as system module which guarantees the supply of the process modules (2) with energy and media, and the supplying module (1/2) takes over centrally the supply of the media needed in the process modules (2) at least for a part of the process modules (2), preferably for all process modules (2) in the production system simultaneously.

22. Production system according to claim 1, characterised in that the production system has a disposal module (1/3) as system module in order to collect and, if necessary, recycle, respectively remove, process wastes and used materials, and a disposal module (1/3) is provided which serves centrally for the disposal of the wastes, used materials for at least of a part of the process modules (2) or the production system altogether, and, if necessary, the disposal module realises a central collection and recycling of these materials.

23. Production system according to claim 1, characterized in that the production system has a disposal module (1/3) as system module in order to collect and, if necessary recycle, respectively remove process wastes and used materials, and the disposal module (1/3) collects, recycles and feeds again the production cycle of the production system with at least a part of the used materials, cooling agents, process gases and the like.

24. Production system according to claim 1, characterised in that the production system has a disposal module (1/3) as system module in order to collect and, if necessary recycle, respectively remove process wastes and used materials, and a disposal module (1/3) is provided which carries out centrally for several, preferably all, process modules (2) the sucking of steam, fog, smoke or the like via a common central suction system.

25. Production system according to claim 1, characterised in that the logistics module (1) has at least one conveying module (1/1) and the conveying module (1/1) is defined by conveying lines like friction roller conveyors, running paths, conveyor belts, slide guides and the like.

26. Production system according to claim 1, characterised in that the logistics module (1) has at least one conveying module (1/1) and the conveying module (1/1) is defined by at least two or more conveyor lines which are arranged in tiers one above the other.

27. Production system according to claim 1, characterised in that the logistics module (1) has at least one conveying module (1/1) and the conveying module (1/1) is defined by at least two or more conveyor lines which are arranged one besides the other.

28. Production system according to claim 1, characterised in that the system module, in particular a supplying module (1/2), a disposal module (1/3) or an operating module has a sound absorbing housing which holds noise producing aggregates like compressors etc.

29. Production system according to claim 1, characterised in that the system module, in particular a supplying module (1/2), a disposal module (1/3) or an operating module, has a sound absorbing housing, which holds noise producing aggregates like compressors etc., and the housing has an air-conditioner, respectively a cooling for dissipating the heat produced by the aggregates.

30. Production system according to claim 1, characterised in that the production system (1) has a supplying module (1/2) as system module which guarantees the supply of the process modules (2) with energy and media, and the supplying module (1/2) contains components for a common supply of several, preferably all, process modules (2), like hydraulic aggregate, cooling-lubrication-agent aggregate, compressed air aggregate, aggregate for thermal stabilisation of the process modules, for example by providing tempered water, gas supply aggregate, energy supply stations and switching stations, respectively aggregates.

31. Production system according to claim 1, characterized in that the production system (1) has a supplying module (1/2) as system module which guarantees the supply of the process modules (2) with energy and media, and a central energy supply, for example contact-free guided conductor rails with separating switches and tapped contact-free or guided by cables, is provided which is integrated in the supplying module(s) (1/2).

32. Production system according to claim 1, characterised by a common fire protection module, respectively system.

33. Production system according to claim 1, characterized in that the different part systems, respectively modules types, are carried out redundantly in particular within the supplying module (1/2).

34. Production system according to claim 1, characterised in that the process module has a logistics element, and the process module can be connected to the logistics element with the logistics module.

35. Production system according to claim 1, characterized by a central supplying module.

36. Production system according to claim 1, characterised by an integrated supplying and disposal module.

37. Production system according to claim 1, characterised by a common stand of the logistics module for a conveying module and a supplying, respectively disposal, module.

38. Production system according to claim 1, characterised in that the logistics module (1) has at least one conveying module (1/1), and the production system (1) has a supplying module (1/2) as system module which guarantees the supply of the process modules (2) with energy and media and, on the one hand, for each conveying module, and, on the other hand, for each of the supplying, respectively disposal, module, individual stands are provided.

39. Production system according to claim 1, characterized in that the process module has a supplying element which can be connected to the supplying module.

40. Production system according to claim 1, characterized in that the production system is designed as machining line.
